(19) United States
(12) Patent Application Publication
(10) Pub. No.: US 2014/0282280 A1
(43) Pub. Date: Sep. 18, 2014

(54) GESTURE DETECTION BASED ON TIME DIFFERENCE OF MOVEMENTS

(71) Applicant: Samsung Electronics Co., Ltd., Gyeonggi-do (KR)

(72) Inventors: Seungmin PACK, Gyeonggi-do (KR); Doowook KIM, Gyeonggi-do (KR); Moonsoo KIM, Seoul (KR); Taegun PARK, Gyeonggi-do (KR)

(73) Assignee: Samsung Electronics Co., Ltd., Gyeonggi-do (KR)

(21) Appl. No.: 14/208,923

(22) Filed: Mar. 13, 2014

Related U.S. Application Data
(60) Provisional application No. 61/781,999, filed on Mar. 14, 2013.

(30) Foreign Application Priority Data
Jan. 6, 2014 (KR) 10-2014-0001051

(51) Int. Cl. G06F 3/0488

(52) U.S. Cl. CPC G06F 3/0488
USPC 715/863; 345/156

(57) ABSTRACT

Disclosed herein are a method and electronic device for detecting or identifying a gesture. A first and second movement are detected. A gesture is identified or detected based at least partially on a time difference between the first and second gesture. A function associated with the gesture is performed.

### CROSS-REFERENCE TO RELATED APPLICATION

This application claims the priority under 35 U.S.C. §119(a) to U.S. Provisional Patent Application Ser. No. 61/781,999, which was filed in the USPTO on Mar. 14, 2013, and Korean Application Serial No. 10-2014-0001051, which was filed in the Korean Intellectual Property Office on Jan. 6, 2014, the entire contents of which are hereby incorporated by reference.

### BACKGROUND

### Technical Field

The present disclosure relates generally to an electronic device, and, in particular, to a method of identifying a gesture of a user through an electronic device.

Electronic devices heretofore, such as portable terminal devices, include an infrared sensor, a camera, and the like in order to detect user input. Such sensors may include proximity sensing. Proximity sensing may allow a portable terminal to detect a gesture by a user without the user contacting the touch screen.

### SUMMARY

The present disclosure is directed to a method and electronic device for identifying a gesture of an external object, such as a portion of a human body (e.g., a finger, a palm, the back of a hand etc.) or a stylus pen. Such gestures may be at least partially intended to be used an input to the electronic device through various sensors. In the present document, the terminology “sensor” may refer to at least one device, component, hardware, firmware, software, or two or more combination thereof configured to sense a gesture by detecting a change of at least one physical phenomenon. For example, the sensor may include a capacitive sensor, a proximity sensor, an IR sensor, an image sensor, an ultrasonic wave sensor, an electromagnetic induction sensor, and/or a touch sensor.

Conventional methods and devices for recognizing a gesture with a sensor may not perform the operation desired by a user because they may detect gestures erroneusly. As will be discussed in more detail below, conventional techniques may have difficulty distinguishing between different movements and may not be able to detect the gesture associated with a particular function.

In one example, a method of operating an electronic device may include detecting a first movement in a first direction; detecting a second movement in a second direction; identifying whether at least one gesture is detectable based at least partially on a time difference between the first and second movement; and, performing a function in the electronic device associated with the at least one gesture, if the gesture is detectable.

In a further example, an electronic device may include at least one sensor, and at least one processor to: detect a first movement in a first direction with the a sensor; detect a second movement in a second direction with a sensor; detect whether at least one gesture is identifiable based at least partially on a time difference between the first and second movement; and perform a function associated with the at least one gesture, if the gesture is identifiable.

Various kinds of movements detected with a proximity sensor may be identified more clearly with the examples of the present disclosure. The aspects, features and advantages of the present disclosure will be appreciated when considered with reference to the following description of examples and accompanying figures.

### BRIEF DESCRIPTION OF THE DRAWINGS

The features and advantages of the present invention will be more apparent from the following detailed description in conjunction with the accompanying drawings, in which:

FIG. 1 is a block diagram illustrating an internal structure of an example electronic device in accordance with aspects of the present disclosure;

FIG. 2 is a block diagram illustrating an internal structure of an example electronic device in accordance with aspects of the present disclosure;

FIG. 3 is an example timing diagram illustrating gesture detection of an electronic device in accordance with aspects of the present disclosure;

FIG. 4A and FIG. 4B are diagrams illustrating example horizontal movements;

FIG. 5A and FIG. 5B are diagrams illustrating example vertical movements;

FIG. 6 is a flow chart illustrating an example method of detecting different in accordance with aspects of the present disclosure;

FIG. 7A and FIG. 7B are diagrams illustrating a further working example in which consecutive movements are identified as gestures in accordance with aspects of the present disclosure;

FIG. 8 is a diagram illustrating a further working example in which the movements are recognized to be one gesture in accordance with aspects of the present disclosure;

FIG. 9 is a diagram illustrating a working example in which consecutive movements are identified as gestures in accordance with aspects of the present disclosure; and

FIG. 10 is a diagram illustrating example functions of an electronic triggered by an identified gesture in accordance with aspects of the present disclosure.

### DETAILED DESCRIPTION

As noted above, conventional gesture detection techniques may have difficulty distinguishing between different movements and may not be able to detect the gesture associated with a particular function. In particular, conventional gesture identification may not be able to detect certain gestures when consecutive movements are being carried out. For example, if a user makes two left-to-right movements along a horizontal axis near an electronic device, the user will need to make one right-to-left movement in between the two left-to-right movements. Thus, this extra right-to-left movement may be detected by the sensor, which may cause the electronic device to detect an erroneous gesture. In this example, the electronic device may identify the gesture as two left-to-right movements and one right-to-left movement, even though the user may have intended to trigger a function associated with a gesture having only two left-to-right movements. Therefore, the user may be forced to, for example, hide the hand in between the left-to-right movements so that the extra right-to-left movement goes undetected and the unintended gesture is not identified. Additionally, if a movement is repeated near the electronic device across different axis, such as a horizontal axis, a vertical axis, or a combination of horizontal and vertical axis, an unintended gesture of the user (or a movement of an object) may be identified.

In veiw of the foregoing, various examples of the present disclosure provide a method and an apparatus for identifying various kinds of gestures. The present disclosure is described with reference to the accompanying drawings. Though detailed descriptions illustrated and related to the drawings are described in the present disclosure, various modifications may be made to provide various embodiments. Therefore, the present description does not limit the application; rather, the scope of the disclosure is defined by the appended claims and equivalents. Furthermore, like elements in the drawings are denoted by like reference numerals.

An electric device according to the present disclosure may be a device configured to identify a gesture. For example, the device may be one or a combination of various devices such as a smart phone, a tablet personal computer (tablet PC), a mobile phone, a video phone, an e-book reader, a desktop personal computer (desktop PC), a laptop personal computer (a laptop PC), a netbook computer, a personal digital assistant (PDA), a portable multimedia player (PMP), an MP3 player, a mobile medical appliance, an electronic bracelet, an electronic necklace, an electronic accessory, a camera, a wearable device, an electronic clock, a wrist watch, a home appliance (for example, a refrigerator, an air conditioner, a vacuum cleaner, an oven, a microwave oven, a washing machine, or an air cleaner), an artificial intelligence robot, a TV, a digital video disk (DVD) player, a stereo system, various kinds of medical appliances (for example, a magnetic resonance angiography (MRA), a magnetic resonance imaging (MRI), a computed tomography (CT), a scanning machine, and ultrasonic equipment), a navigator, a global positioning system receiver (GPS receiver), an event data recorder (EDR), a flight data recorder (FDR), a set-top box, a TV box (for example, Samsung HomeSync™, Apple TV™, or Google TV™), an electronic dictionary, an automotive infotainment apparatus, electronic device for ship (for example, navigation equipment for ship, and a gyro compass), avionics, security equipment, electronic clothes, an electronic key, a camcorder, a game console, a head-mounted display (HMD), a flat panel display device, an electronic photo frame, an electronic photo album, furniture or a part of a building/structure including a communication function, an electronic board, an electronic signature receiving device, or a projector. It is understood that the electronic devices are not limited to the devices mentioned above.

FIG. 1 is a block diagram illustrating an internal structure of a electronic device 100 in accordance with aspects of the present disclsoure.

As illustrated in FIG. 1, the electronic device 100 may include a wireless communication unit 110, a sensor unit 120, a touch screen unit 130, an input unit 140, a storage unit 150, and a control unit 160. Here, if the electronic device does not support a communication function, a configuration of the wireless communication unit 110 may be omitted.

The wireless communication unit 110 may form a communication channel in order to support at least one of voice communication, video communication, and data communication functions of the electronic device 100. The communication unit may include various communication modules such as a mobile communication module (at least one module that may provide various communication schemes including 2G, 3G, 4G, and the like), a WiFi module, a near field communication module, and the like.

The wireless communication unit 110 may be configured with an RF transmitter that performs up-conversion and amplification on a frequency of a transmitted signal, an RF receiver that performs low-noise amplification and down-conversion on a frequency of a received signal, and the like. In addition, the wireless communication unit 110 may receive data through a wireless channel to output the data to the control unit 160, or transmit the data output from the control unit 160 through the wireless channel.

According to various embodiments of the present disclosure, the wireless communication unit 110 may support specific function activation in response to the gesture identification described herein. For example, the communication unit may support communication call reception, and receive a signal from control unit 160 in response to a gesture to accept the communication call reception and form a communication channel with other electronic devices.

Further, the wireless communication unit 110 may be connected to a specific server device and receive a server page provided by the service device. Such a server page may be a web-based web page. The server page provided by the wireless communication unit 110 may be scrolled in response to a user gesture. For example, the server page may change a scroll type by receiving a signal from the control unit 160 in response to various user gestures (a continuous gesture operation in a single direction, a continuous bi-directional gesture, bi-directional gestures with a certain time interval, and the like).

The sensor unit 120 may include an acceleration sensor, a gravity sensor, an optical sensor, a gesture recognizing sensor, a Green Blue Red (GBR) sensor, and the like. For example, the sensor unit 120 of the electronic device 100 according to embodiments of the present disclosure may include a proximity sensor.

The proximity sensor may detect whether an object including the user approaches the electronic device 100. The proximity sensor may be a sensor used for positional control and detection of existence, a passage, a continuous flow, or a hold of an object using a electromagnetic field without a physical contact, and may use a detection principle such as high-frequency oscillation scheme, a capacitance scheme, a magnetic scheme, a photoelectric scheme, an ultrasonic scheme, and the like.

For example, the proximity sensor may include a capacitance sensor (for example, a sensor including a capacitor array), a proximity sensor, an IR sensor, an image sensor, an ultrasonic wave sensor, an electromagnetic induction sensor, a touch sensor, or a combination of two or more of the sensors. However, the proximity sensor is not limited to the sensors described above. For example, a touch sensor may be operated as a proximity sensor if the sensitivity of the touch sensor is improved.

In one example, the sensor unit 120 may receive a user gesture with a distance from a surface of the electronic device 100 using such a proximity sensor.

In another example, though it is not illustrated in FIG. 1, the electronic device 100 may further include an audio processing unit. The audio processing unit may be configured with a codec, and the codec may be configured with a data codec that processes packet data and the like, and an audio codec that processes audio signals such as a voice and the like. The audio processing unit may convert a digital audio signal into an analog audio signal by the audio codec to reproduce the analog audio signal through a speaker SPK, and may convert an analog audio signal input from a microphone MIC into a digital audio signal through the audio codec.

The touch screen unit 130 may include a touch panel 134 and a display unit 136. The touch panel 134 may sense a user touch input. The touch panel 134 may be configured with a touch sensor in a capacitive overlay scheme, a resistive overlay scheme, an infrared beam scheme, or the like, or may be configured with a pressure sensor. In addition to the sensors described above, all kinds of sensors that may sense a contact or a pressure of an object may be configured as the touch panel 134 according to the embodiment of the present disclosure.

The touch panel 134 may sense a touch input of a user, generate a sensing signal, and transmit the sensing signal to the control unit 160. The sensing signal may include coordinate data of a position in which the user inputs a touch. If the user inputs a touch position movement gesture, the touch panel 134 may generate a sensing data including coordinate data of a touch position movement course and may transmit the sensing data to the control unit 160.

The display unit 136 may be configured with a Liquid Crystal Display (LCD), an Organic Light Emitting Diodes (OLED), an Active Matrix Organic Light Emitting Diodes (AMOLED), and the like, and visually provides a menu, input data, function setting information, and various kinds of information of the electronic device 100 to the user. Further, the display unit 136 may display various kinds of information for informing the user of an operation state of the electronic device 100.

The electronic device 100 may include a touch screen as described above. However, it should be understood that the examples herein are not just applicable to an electronic device 100 having a touch screen. If the present disclosure is applied to a portable terminal that does not include a touch screen, the touch screen unit 130 illustrated in FIG. 1 may be changed and applied to perform only the function of the display unit 136, and the function performed by the touch panel 134 may be substituted by the sensor unit 120 or the input unit 140.

The input unit 140 may receive an input of a user for controlling the electronic device 100, may generate an input signal, and may transmit the input signal to the control unit 160. The input unit 140 may be a key pad including number keys and arrow keys, and may be formed with certain function keys on one side of the electronic device 100.

FIG. 1 illustrates the sensor unit 120 and the input unit 140 as separate blocks, but the configuration is not limited thereto. That is, the electronic device 100 may receive a user input without physical contact by the sensor unit 120.

The storage unit 150 may store a program or data required for an operation of the electronic device 100 and may be divided into a program area and a data area.

The program area may store programs for controlling overall operations of the electronic device 100 and programs provided by the portable terminal as default such as an Operating System (OS) for booting the electronic device 100. Further, the program area of the storage unit 150 may store applications separately installed by the user, for example, a game application, a social network service executing application, and the like. The data area is an area in which data generated by using the electronic device 100 is stored.

The control unit 160 may control the overall operation of the components.

FIG. 2 illustrates a block diagram of a hardware 200 according to other embodiments of the present disclosure. The hardware 200 may be the electronic device 100 illustrated in FIG. 1. With reference to FIG. 2, the hardware 200 may include at least one of a processor 210, a subscriber identification module (SIM) card 214, a memory 220, a communication module 230, a sensor module 240, a user input module 250, a display module 260, an interface 270, an audio codec 280, a camera module 291, a power managing module 295, a battery 296, an indicator 297, and a motor 298.

The processor 210 (for example, the processor 120) may include at least one application processor (AP) 211 or at least one communication processor (CP) 213. For example, the processor 210 may be the processor 120 illustrated in FIG. 1. FIG. 2 illustrates that the AP 211 and the CP 213 are included in the processor 210, but the AP 211 and the CP 213 may be included in different IC packages, respectively. According to the embodiment, the AP 211 and the CP 213 may be included in one IC package.

The AP 211 may drive an operation system or an application program, control a plurality of hardware or software components connected to the AP 211, and processes or calculate various kinds of data including multimedia data. The AP 211 may be embodied, for example, by a system on chip (SoC). According to the embodiment, the processor 210 may further include a graphic processing unit (GPU) (not illustrated).

The CP 213 may perform a function of managing data link and converting a communication protocol in a communication between an electronic device (for example, the electronic device 100) including the hardware 200 and another electronic device connected through a network. For example, the CP 213 may be embodied, for example, by an SoC. According to the embodiment, the CP 213 may perform at least a part of multimedia control function. The CP 213 may differentiate and authenticate an electronic device in a communication network, for example, by using a subscriber identification module (for example, the SIM card 214). In addition, the CP 213 may provide services such as a voice communication, a video communication, a text message, or packet data to the user.

In addition, the CP 213 may control data transmission and reception of the communication module 230. FIG. 2 illustrates that components such as the CP 213, the power managing module 295, the memory 220 are separate from the AP 211, but according to the embodiment, the AP 211 may include at least a part of the components described above (for example, the CP 213).

In one example, the AP 211 or the CP 213 may load and process an instruction or data received from at least one of a non-volatile memory or other components connected to each of them on a volatile memory. Further, the AP 211 or the CP 213 may store data received from at least one of the other components or generated by at least one of the other components on the non-volatile memory.

The SIM card 214 may be a card embodied by a subscriber identification module, and may be inserted to a slot formed in a certain position of the electronic device. The SIM card 214 may include unique identification information (for example, an integrated circuit card identifier (ICCID)) or subscriber information (for example, an international mobile subscriber identity (IMSI)).

The memory 220 may include an internal memory 222 or an external memory 224. For example, the memory 220 may be the storage unit 150 in FIG. 1. For example, the internal memory 222 may include at least one of a volatile memory (for example, a dynamic RAM (DRAM), a static RAM (SRAM), or a synchronous dynamic RAM (SDRAM)) or a non-volatile memory (for example, a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). According to the embodiment, the internal memory 222 may have a form of a Solid State Drive (SSD). The external memory 224 may further include a flash drive, such as a compact flash (CF), a secure digital (SD), a micro secure digital (Micro-SD), a mini secure digital (Mini-SD), an extreme digital (xD), or a Memory Stick.

The communication module 230 may further include a wireless communication module 231 or an RF module 234. The communication module 230 may be, for example, the wireless communication unit 110 illustrated in FIG. 1. The wireless communication module 231 may include, for example, a WiFi module 233, a bluetooth (BT) module 235, a GPS module 237, or a near field communication (NFC) module 239. For example, the wireless communication module 231 may provide a wireless communication function by using a wireless frequency. Additionally or in substitution, the wireless communication module 231 may include a network interface (for example, a LAN card) or a modem for connecting the hardware 200 to a network (for example, the Internet, a local area network (LAN), a wire area network (WAN), a telecommunication network, a cellular network, a satellite network, or a plain old telephone service (POTS)).

The RF module 234 may transmit and receive data, for example, an RF signal or a called electric signal. Though it is not illustrated in the drawings, the RF module 234 may include a transceiver, a power amp module (PAM), a frequency filter, or a low noise amplifier (LNA)) Further, the RF module 234 may further include a component for transmitting and receiving an electronic frequency in a free space in a wireless communication, for example, a conductor or a conducting wire.

The sensor module 240 may include, for example, at least one of a gesture sensor 240A, a gyro sensor 240B, a barometric pressure sensor 240C, a magnetic sensor 240D, an acceleration sensor 240E, a grip sensor 240F, a proximity sensor 240G, an RGB (red, green, blue) sensor 240H, a bionic sensor 240I, a temperature/humidity sensor 240J, an illumination sensor 240K, or an ultra violet (UV) sensor 240M. The sensor module 240 may measure a physical amount and sense an operation state of the electronic device to convert the measured or sensed information into an electric signal. Additionally or in substitution, the sensor module 240 may include, for example, an E-nose sensor (not illustrated), an electromyography sensor (EMG sensor) (not illustrated), an electroencephalogram sensor (EEG sensor) (not illustrated), an electrocardiogram sensor (ECG sensor) (not illustrated), or a fingerprint sensor. The sensor module 240 may further include a control circuit for controlling at least one of sensors included in the control circuit.

The user input module 250 may include a touch panel 252, a (digital) pen sensor 254, a key 256, or an ultrasonic input device 258. The user input module 250 may be, for example, the input unit 140 illustrated in FIG. 1. The touch panel 252 may recognize a touch input, for example, by at least one of a capacitive overlay scheme, a resistive overlay scheme, an infrared beam scheme, or an ultrasonic scheme. Further, the touch panel 252 may further include a controller (not illustrated). In the case of the capacitive overlay scheme, not only a direct touch but also proximity recognition are possible. The touch panel 252 may further include a tactile layer. In this case, the touch panel 252 may provide tactile feedback to the user.

The (digital) pen sensor 254 may be embodied, for example, by using the same or similar method of receiving a user touch input or by using a separate sheet for recognition. For example, a keypad or a touch key may be used as the key 256. The ultrasonic input device 258 is a device that uses a pen that generates an ultrasonic wave and checks data by sensing the sound wave with a microphone (for example, a microphone 288), so wireless recognition is possible. According to the embodiment, the hardware 200 uses the communication module 230 so as to receive a user input from an external device (for example, a network, a computer, or a server) connected thereto.

The display module 260 may include a panel 262 or the hologram 264. The display module 260 may be, for example, the touch screen 130 illustrated in FIG. 1. The panel 262 may be, for example, a liquid-crystal display (LCD) or an active-matrix organic light-emitting diode (AM-OLED). The panel 262 may be embodied, for example, in a flexible, transparent, or wearable manner. The panel 262 may be embodied with the touch panel 252, as one module. The hologram 264 may show a stereoscopic image in the art by using interference of light. According to the embodiment, the display module 260 may further include a control circuit for controlling the panel 262 or the hologram 264.

The interface 270 may include, for example, a high-definition multimedia interface (HDMI) 272, a universal serial bus (USB) 274, a projector 276, a D-subminiature (D-sub) 278. Additionally or in substitution, the interface 270 may include, for example, a secure Digital (SD)/multi-media card (MMC)(not illustrated) or an infrared data association (IrDA) (not illustrated).

The audio codec 280 may convert a voice signal and an electric signal bidirectionally. The audio codec 280 may convert voice information, for example, which is input or output through a speaker 282, a receiver 284, an ear phone 286, or the microphone 288.

The camera module 291 is a device that may capture a still image or a moving image. According to the embodiment, the camera module 291 may include one or more image sensors (for example, a front lens or a rear lens), an image signal processor (ISP) (not illustrated) or a flash LED (not illustrated).

The power managing module 295 may manage electric power of the hardware 200. Though it is not illustrated, the power managing module 295 may include, for example, a power management integrated circuit (PMIC), a charger integrated circuit (charger IC), or a battery fuel gauge.

The PMIC may be mounted, for example, on an integrated circuit or an SoC semiconductor. The charging method may be divided into a wired method and a wireless method. The charger IC may charge a battery, and prevent the incoming of overvoltage or overcurrent from the charger. According to the embodiment, the charger IC may include a charger IC for at least one of a wired charging method and a wireless charging method. The wireless charging method may be, for example, a magnetic resonance scheme, a magnetic induction scheme, or an electromagnetic wave scheme, and additional equipment for the wireless charging, for example, a circuit such as a loop coil, a resonant circuit, or a rectifier may be added.

The battery gauge may measure, for example, a residual amount, a charging voltage, electric current, or a temperature of the battery 296. The battery 296 may generate electricity to supply electric power, and may be, for example, a rechargeable battery.

The indicator 297 may display a specific condition of the hardware 200 or a part thereof (for example, the AP 211), for example, a booting state, a message state, or a charging state. The motor 298 may change an electric signal into a mechanical vibration. The MCU 299 may control the sensor module 240.

Though not illustrated, the hardware 200 may include a processing device for supporting a mobile TV (for example, a GPU). The processing device for supporting the mobile TV may process media data, for example, conforming to a standard of a digital multimedia broadcasting (DMB), a digital video broadcasting (DVB), or a media flow. The aforementioned elements of the hardware according to the present disclosure each may be configured with one or more components, and the names of the components may be different according to the kinds of the electronic device. The hardware according to the present disclosure may be configured to include at least one of the components described above, and some of the components may be omitted and additional components may be further included. Further, some of the components of the hardware according to the present disclosure may be combined to configure one entity so that a function of the corresponding component before the combination may be performed in the same manner.

The terminology “module” as used in the present disclosure may mean, for example, a unit including one or a combination of hardware, software, or firmware. The module may be interchangeably used in substitution for the terminology such as a unit, logic, a logical block, a component, or a circuit. The module may be a minimum unit of an integrally configured component or a part thereof. The module may be a minimum unit of performing one or more functions, or a part thereof. The module may be implemented mechanically or electronically. For example, the module according to the present disclosure may include at least one of an application-specific integrated circuit (ASIC) chip, field-programmable gate arrays (FPGAs), or a programmable-logic device, which performs known or to-be-developed operations.

With reference to FIGS. 1 to 9, the control unit 160 of the electronic device 100 according to one example may control a series of operations for identifying a first and second movement and a time difference T therebetween. Control unit 160 may also determine if the first and second movement travel along a substantially similar axis (e.g., left to right or right to left along a horizontal axis).

In one example, if the time difference T is greater than or equal to a predetermined first threshold, the control unit 160 may identify a first gesture based on the first movement and identify a second gesture based on the second movement such that the each gesture is an independent gesture. In another example, if the difference T is also smaller than a predetermined second threshold, the control unit 160 may identify one gesture based on both the first and second movement. In yet a further example, if the difference T is greater than or equal to the second threshold but smaller than the first threshold, the control unit 160 may identify or detect a first gesture based on the first movement while ignoring the second movement.

FIG. 3 is an example timeline in accordance with aspects of the present disclosure. In FIG. 3, if the electronic device 100 detects a second movement at time A after receiving a first movement 301, time A is greater than or equal to the first threshold 302, thus electronic device 100 may detect a first gesture based on the first movement and a second gesture based on the second movement.

If the electronic device 100 detects the second movement at time B after detecting first movement 301, time B is smaller than the first threshold value 302 but greater than or equal to the second threshold value 303, thus electronic device 100 may identify one gesture based on the first movement and ignore the second movement.

If the electronic device 100 receives the second movement at time C after receiving the first movement 301, time C is smaller than the first threshold 302 and smaller than the second threshold 303, thus the electronic device 100 may identify one gesture based one the first and second movement.

In one example, the first threhsold may be approximately 500 ms and the second threshold may be approximtaly 300 ms. In another example the first and second threshold may be equal or may have different values.

Various sophisticated gestures beyond simple left-to-right and right-to-left gestures may be identified by considering the time difference between left-to-right and right to left movements in front of a sensor. Detecting the time difference between movements may provide more proper gesture identification when continuous movements are identified (when repetitive right-to-left and left-to-right movements are carried out). For example, a second movement may be ignored, if the second movement was carried within some predetermined threshold after the first movement. Thus, an electronic device may identify one gesture based on the first movement only. Furthermore, the present disclosure may be applied for more kinds of movements by enabling the electronic device to recognize a new gesture, such as, a hand waving gesture. The hand waving gesture may be enabled by configuring different movements and time thresholds. For example, if the second movement is detected within a predetermined time after the first movement and the first movement is detected within a predetermined time after the second movement, the electronic device 100 may not identify the movements individually, but may identify one gesture based on both movements (e.g., a hand vaving gesture based on a left-to-right and right-to-left movement).

FIGS. 4A and 4B are diagrams illustrating left-to-right and right-to-left gestures. FIGS. 4A and 4B depict an electronic device 100 having a sensor 120 that supports proximity sensing. A left-to-right movement is illustrated in FIG. 4A and a right-to-left movement is illustrated in FIG. 4B. The left-to-right movement of FIG. 4A may be referred to as the first movement and the right-to-left movement of FIG. 4 B may be referred to as the second movement. In this example, the first and second movement travel along the horizontal axis.

The user may generate movements such that the first and second movements are performed continuosly (e.g., moving hand 10 in a left-right-left-right etc.). Here, a user may intend to make a gesture involving only two left-to-right movements. On the other hand, the user may intend to make a gesture involving left-to-right and right-to-left movements such that the gesture is based on both movements, such as a hand waving movement along the horizontal axis. However, as will be addressed in more detail below, the movements detected by sensor 120 supporting proximity sensing are along the same horizontal axis (i.e., left-right-left-right sides).

FIGS. 5A and 5B are diagrams illustrating movements of hand 10 along a vertical axis (i.e., from top to bottom and from bottom to top) over electronic device 100 having a sensor 120 that supports proximity sensing. In this example, movements from top to bottom as illustrated in FIG. 5A may be referred to as a first movement and movements from bottom to top as illustrated in FIG. 5B may be referred to as a second movement. The user may carry out movements so that the first and second movements are performed continuosly. For example, the user may generate the gestures in an up-down-up-down direction continuosly.

In the example of FIGS. 5A and 5B, the user may intend to make a gesture involving two top-to-bottom movements. On the other hand, the user may intend to make one gesture based on the first movement and a second gesture based on the second movement. Alternatively, a user may intend to make a gesture involving both first and second movements together, such as a vertical hand waving gesture.

However, as will be addressed in FIG. 6, the movements detected by sensor 120 supporting proximity sensing are along the same vertical axis (i.e., top-bottom-top-bottom sides).

FIG. 6 is a flow chart illustrating an example method of identifying gestures in accordance with aspects of the present disclosure.

In block 610, the control unit 160 may activate the sensor unit 120 so that a movement within a predetermined proximity of electronic device 100 may be detected without physical contact therewith. In one example, a proximity sensor may be activated in block 610, but the examples herein are not limited to proximity sensors. For example, motion may be detected through a camera such that the camera may be activated in block 610 in lieu of a sensor unit 120. The sensor unit may include a capacitive sensor, an IR sensor, an ultrasonic wave sensor, and an electromagnetic induction sensor, and the like.

In block 620, the control unit 160 may detect a first movement with sensor unit 120. In block 630, the control unit 160 may detect a second movement using sensor unit 120. In block 640, control unit 160 may detect whether the first and second movement travel along a substantially similar axis (e.g. a horizontal axis or a vertical axis).

If the first and second movement travel along a substantially different axis, controller 160 may detect a first gesture based on the first movement and a second gesture based on the second movement, in block 645. For example, if the first movement is left to right, and the second movement is top to bottom, control unit 160 may detect a first gesture based on the first movement and a second gesture based on the second movement.

If the first and second movement travel along a substantially similar axis, the control unit 160 may detect whether at least one gesture is identifiable based at least partially on a time difference between the first and second movement in blocks 650 and 660.

In particular, if the time difference T is greater than a first threshold N₁ in block 650, control unit 160 may identify a first gesture based on the first movement and a second gesture based on the second movement, in block 645.

By way of example, if the user turns a page of an e-book from page 1 to page 2 and wants to check back to page 1, the user may carry out the second movement at some time after carrying out the first movement. The time is considered in blocks 650 and 645.

FIGS. 7A and 7B are diagrams illustrating examples in which consecutive gestures are recognized as independent gestures in respective directions.

When the user moves hand 10 over electronic device 100 having a sensor 120 that supports proximity sensing and the user carries out top-to-bottom, bottom-to-top movements as illustrated in FIGS. 7A and 7B, each movement may be identified as independent movements due to a time difference between the movements. However, if time difference T is smaller than a first threshold N₁ in block 650 and smaller than the second threshold N₂ in step 660, control unit 160 may identify one gesture based on the first and second movement in block 665 and not a first gesture independent of a second gesture.

For example, if it is predetermined that the electronic device will change to voice input mode when a hand waving gesture is made along the horizontal axis, the user may generate movements such that the second movement is generated right after the first movement. This time between the movements is considered in blocks 660 and 665.

FIG. 8 illustrates a working example in which consecutive movements are identified as one gesture regardless of the axis along which the movements travel.

When the user moves hand 10 over electronic device 100 having a sensor 120 that supports proximity sensing and the user makes a horizontal hand waving gesture as illustrated in FIG. 8, the hand waving gesture may be identified as an independent gesture regardless of which axis the hand travels. Instead, identification of the hand waving gesture may be based on a time difference between the movements.

In another example, if the time difference T is smaller than the first threshold N₁ in block 650 greater than the second time threshold N₂ in block 660, the control unit 160 may identify one gesture based on the first movement while ignoring the second movement. For example, if a user desires to turn from page 1 to page 2 and then 3 in an e-book, the user may consecutively generate the first movement only. Furthermore, since a second movement in another direction may be detected while repeating the first movement, the user may make a hand gesture in a first movement-second movement-first movement order. Here, the second movement may be ignored in view of the times considered in blocks 650 and 645.

FIG. 9 is a diagram illustrating a working example in which consecutive gestures are recognized as gestures in one direction.

If the user moves hand 10 over electronic device 100 having a sensor 120 that supports proximity sensing and the user desires to make a gesture involving two left-to-right movements, but a right-to-left movement is made in between in order to make the two left-to-right movements, the two left-to-right movements may be identified as two repetitive gestures while ignoring the intermittent right-to-left movement in view of a time difference between the movements.

FIG. 10 is a diagram illustrating a function of the electronic device 100, in which the function is associateed with a gesture. The electronic device 100 may change at least a portion of a page, an image, a text, or at least one icon displayed on a display module 260 by identifying the associated gesture by hand 10 of the user.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps may be handled in a different order or simultaneously, and steps may be omitted or added.

What is claimed is:

1. A method comprising:
detecting, using an electronic device, a first movement in a first direction;
detecting, using the electronic device, a second movement in a second direction;
identifying, using the electronic device, whether at least one gesture is detectable based at least partially on a time difference between the first and second movement; and
performing, using the electronic device, a function in the electronic device associated with the at least one gesture, when the gesture is detectable.

2. The method according to claim 1, further comprising detecting a first gesture based on the first movement and a second gesture based on the second movement, when the time difference is equal to or greater than a first threshold and the first and second movement travel along a substantially similar axis.

3. The method according to claim 1, further comprising detecting one gesture based on the first and second movement, if the time difference is less than a first threshold and a second threshold and the first and second movement travel along a substantially similar axis.

4. The method according to claim 1, further comprising detecting one gesture based on the first movement while ignoring the second movement, when the time difference is smaller than a first threshold and greater than or equal to a second threshold and the first and second movement travel along a substantially similar axis.

5. The method according to claim 1, further comprising detecting a first gesture based on the first movement and a second gesture based on the second movement, when the first and second movement travel along a substantially different axis.

6. The method according to claim 1, wherein detecting the first and second movement comprises using at least one of a proximity sensor, an infrared (IR) sensor, an image sensor, an ultrasonic wave sensor, an electromagnetic induction sensor, a capacitive sensor, or a touch sensor.

7. The method according to claim 1, wherein detecting the first and second movement comprises detecting a movement near a display of the electronic device.

8. The method according to claim 1, wherein performing the function comprises changing at least a portion of a page, an image, a text, or at least one icon rendered on a display of the electronic device.

9. The method according to claim 1, wherein performing the function comprises substituting or changing a screen rendered on a display of the electronic device.

10. The method according to claim 1, wherein performing the function comprises starting or terminating a communication in response to a signal received by the electronic device.

11. An electronic device, comprising:
at least one sensor; and
at least one processor to:
detect a first movement in a first direction with the at least one sensor;
detect a second movement in a second direction with the at least one sensor;
detect whether at least one gesture is identifiable based at least partially on a time difference between the first and second movement; and
perform a function associated with the at least one gesture, when the gesture is identifiable.

12. The electronic device according to claim 11, wherein the at least one processor to identify a first gesture based on the first movement and a second gesture based on the second movement, when the time difference is equal to or greater than a first threshold and the first and second movement travel along a substantially similar axis.

13. The electronic device according to claim 11, wherein the at least one processor to identify one gesture based on the first and second movement, when the time difference is less than a first threshold and a second threshold and the first and second movement travel along a substantially similar axis.

14. The electronic device according to claim 11, wherein the at least one processor to identify one gesture based on the first movement while ignoring the second movement, when the time difference is smaller than a first threshold and greater than or equal to a second threshold and the first and second movement travel along a substantially similar axis.

15. The electronic device according to claim 11, wherein the at least one processor to identify a first gesture based on the first movement and a second gesture based on the second movement, when the first and second movement travel along a substantially different axis.

16. The electronic device according to claim 11, wherein the sensor includes at least one of a proximity sensor, an infrared (IR) sensor, an image sensor, an ultrasonic wave sensor, an electromagnetic induction sensor, a capacitive sensor, or a touch sensor.

17. The electronic device according to claim 11, wherein the at least one processor to detect a movement near a display of the electronic device.

18. The electronic device according to claim 11, wherein to perform the function the at least one processor to change at least a portion of a page, an image, a text, or at least one icon displayed on a display of the electronic device.

19. The electronic device according to claim 11, wherein to perform the function the at least one processor to substitute or change a screen displayed on a display of the electronic device.

20. The electronic device according to claim 11, wherein to perform the function the at least one processor to start or terminate a communication in response to a signal received by the electronic device.
